(19) United States
(12) Patent Application Publication
(10) Pub. No.: US 2007/0288405 A1
(43) Pub. Date: Dec. 13, 2007

(54) PROBLEM SOLVING MECHANISM SELECTION FACILITATION APPARATUS AND METHOD

(75) Inventors: John C. Strassner, North Barrington, IL (US); Barry J. Menich, South Barrington, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/422,671

(22) Filed: Jun. 7, 2006

(51) Int. Cl. G06F 15/18

(52) U.S. Cl. 706/12

(57) ABSTRACT

An autonomic computational processor can be provided with both at least one substantially closed loop problem solving mechanism (such as, but not necessarily limited to, an abductive algorithm-based problem solving mechanism (101)) and at least one substantially open loop problem solving mechanism (such as, but not necessarily limited to, a machine learning algorithm-based problem solving mechanism (102)). Upon receiving (103) information regarding a problem as relates to a given corresponding process, then, these teachings can provide for automatically determining (104) which of the closed loop and open loop problem solving mechanisms to use to attempt to resolve the problem.

### RELATED APPLICATIONS

AUTONOMIC COMPUTING METHOD AND APPARATUS as is filed concurrently with present application using attorney's docket number CML03322N;

METHOD AND APPARATUS FOR AUGMENTING DATA AND ACTIONS WITH SEMANTIC INFORMATION TO FACILITATE THE AUTONOMIC OPERATIONS OF COMPONENTS AND SYSTEMS as is filed concurrently with present application using attorney's docket number CML03000N; and

METHOD AND APPARATUS FOR HARMONIZING THE GATHERING OF DATA AND ISSUING OF COMMANDS IN AN AUTONOMIC COMPUTING SYSTEM USING MODEL-BASED TRANSLATION as is filed concurrently with present application using attorney's docket number CML02977N; wherein the contents of each of these related applications are incorporated herein by this reference.

### TECHNICAL FIELD

This invention relates generally to at least partially automated problem solving mechanisms.

### BACKGROUND

Autonomic computing systems are known in the art. Such systems are typically viewed as comprising a type of computing model in which the system has self-governing capabilities such that self-healing, self-configuration, self-protection, and self-management functions are enabled. In many cases this capability is facilitated, in whole or in part, via a relatively high level of artificial intelligence. Viewed generally, an autonomic computing environment operates relatively independently in response to collected inputs. In many cases this operation occurs relatively transparently to users.

Autonomic computing systems often comprise some degree of problem solving capability. The specific problems to be solved, of course, will vary with the application setting. When the autonomic computing system is arranged and configured to facilitate surveillance of communications network traffic data and/or network traffic status, problems to be solved can arise when the autonomic computing system confronts an unrecognized process state or process event.

Various approaches are known in the art by which an autonomic computing system can attempt to solve a given problem. As one example, machine learning algorithm-based problem solving mechanisms are known. As another example, abductive algorithm-based problem solving mechanisms are also known. Unfortunately, at least at present, no single problem solving mechanism appears to offer a rapid, efficient, assured means to an optimum (or even an acceptable) solution in all cases. Instead, each problem solving mechanism has its relative pluses and minuses.

By one approach, one might select a given problem solving mechanism as might be expected to work best for the majority of problems that might be faced by a given autonomic computing system. Even this approach, however, represents only a compromise as, almost by definition, the selected mechanism will be less than optimal for at least some problems as may be presented in a given application setting.

### BRIEF DESCRIPTION OF THE DRAWINGS

The above needs are at least partially met through provision of the problem solving mechanism selection facilitation apparatus and method described in the following detailed description, particularly when studied in conjunction with the drawings, wherein:

FIG. 1 comprises a flow diagram as configured in accordance with various embodiments of the invention;

FIG. 2 comprises a block diagram as configured in accordance with various embodiments of the invention;

FIG. 3 comprises a flow diagram as configured in accordance with various embodiments of the invention; and

FIG. 4 comprises a flow diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, an autonomic computational processor can be provided with both at least one substantially closed loop problem solving mechanism (such as, but not necessarily limited to, an abductive algorithm-based problem solving mechanism) and at least one substantially open loop problem solving mechanism (such as, but not necessarily limited to, a machine learning algorithm-based problem solving mechanism). Upon receiving information regarding a problem as relates to a given corresponding process, then, these teachings can provide for automatically determining which of the closed loop and open loop problem solving mechanisms to use to attempt to resolve the problem.

The basis of this determination can and will vary with the needs and/or capabilities offered by a given application and/or problem-solving setting. By one approach, this automatic determination can comprise, at least in part, determining whether sufficient supplemental information (such as semantical information and/or contextual tags as may be available and provided) has been received or otherwise made available to facilitate using a closed loop problem solving mechanism. When sufficient supplemental is indeed available, these teachings can then further provide for determining whether a potentially useful closed loop problem solving mechanism is, in fact, available.

So configured, an autonomic computing system can have, in effect, the best of both worlds. Rather than accepting the design and operational compromise of being limited to only a single primary approach to automated problem solving, the system can have a variety of considerably different problem solving approaches available and a capability of making a meaningful selection as amongst those approaches in a given instance. This, in turn, can lead to yet greater expected operational autonomy and/or a more effective system platform.

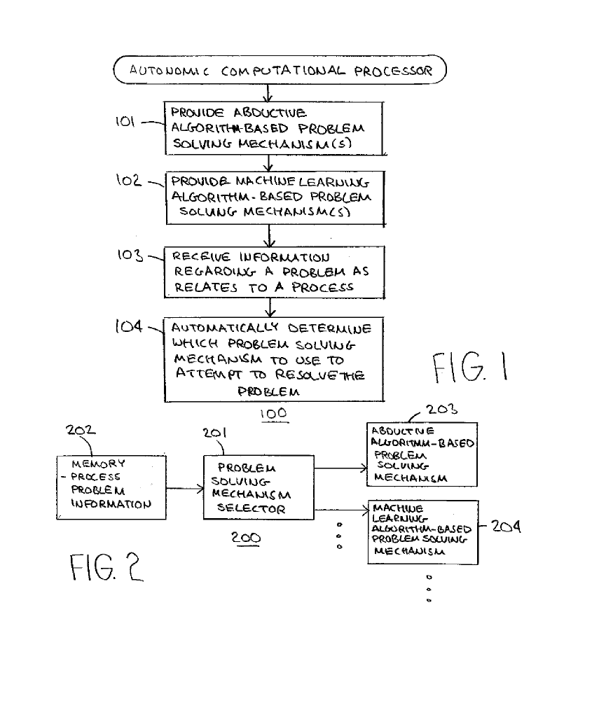

These and other benefits may become clearer upon making a thorough review and study of the following detailed description. Referring now to the drawings, and in particular to FIG. 1, a corresponding process 100 as carried out by an autonomic computational processor of choice provides 101 at least one abductive algorithm-based problem solving mechanism. Abduction, of course, comprises reaching a best explanation through reasoning. In general, abductive approaches derive likely explanations as correspond to a set of initial facts to effectively explain that which is known. Various abductive algorithm-based problem solving mechanisms are known in the art. As the present teachings are not overly sensitive to the selection of any particular approach in this regard, for the sake of brevity additional detailed elaboration will not be provided here regarding such mechanisms.

This process 100 also provides 102 at least one (and very likely more) machine learning algorithm-based problem solving mechanism. Machine learning approaches are also known in the art and typically comprise a computer program that can learn from a given experience with respect to some class of tasks and at least one corresponding performance measure. In particular, such a program can typically search through a space of possible hypotheses and identify a particular hypothesis that best fits the available training examples and other applicable prior constraints and/or knowledge. So configured, such a program has the ability to learn over time by performing a set of tasks with increasing experiential-based improvement.

So provisioned, this process 100 then provides for permitting reception 103 of information regarding a problem as relates to a process. When the autonomic computational processor comprises one that facilitates network traffic data and/or network traffic status, this process may therefore also comprise the process of facilitating that network traffic data and/or network traffic status. The nature of the problem may of course vary with the specifics of a given application setting. By one approach, however, this problem can relate to at least one of an occurrence of an unrecognized process state and/or an unrecognized process event. (Detection of such unrecognized states/events is known in the art and requires no further description here.)

This step of receiving 103 such information can accordingly comprise, by one approach, receiving event-based information regarding process state information and/or process event information. By one approach, this information can further comprise supplemental information of interest as may be available in a given application setting. Examples of supplemental information include, but are not limited to, semantical information and one or more contextual tags. Additional description regarding such supplemental information appears below.

This process 100 then provides for automatically determining 104 which of the aforementioned problem solving mechanisms to use to attempt to resolve this problem. At a minimum, in this illustrative example this can comprise making an appropriate selection as between the abductive algorithm-based problem solving mechanism and the machine learning algorithm-based problem solving mechanism. By one approach, this automatic determination 104 can comprise, at least in part, determining whether sufficient supplement information has been received to reasonably support using an abductive algorithm-based problem solving method. When sufficient supplemental information indeed appears to be available, this automatic determination 104 can then further comprise, if desired, determining whether a potentially useful abductive algorithm-based problem solving mechanism is available.

So configured, when sufficient information to support an abductive approach exists and when a sufficiently likely useful abductive mechanism is also available, this process 100 can support the automatic selection of that abductive algorithm-based problem solving mechanism. When, however, a sufficient basis to support an abductive approach does not exist, this process 100 permits an automatic determination to use a machine learning algorithm-based problem solving mechanism instead.

Such an approach, of course, runs contrary to more typical prior art practice in this regard. By providing for an automated selection capability as between an abductive approach on the one hand and a machine learning approach on the other hand, however, an autonomic computational processor can be rendered more capable of handling a wider range of potentially disruptive problems in an autonomous fashion. This, in turn, can lead to greater process reliability, efficiency, and economy.

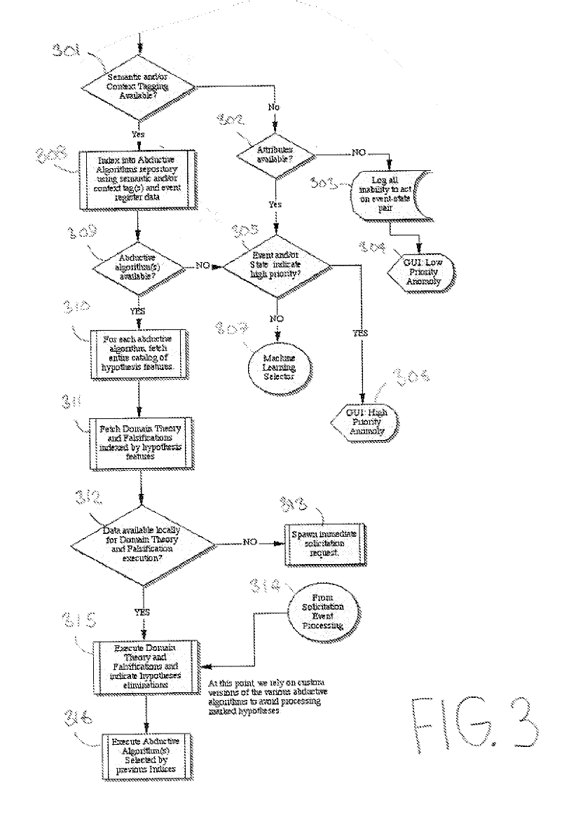

Those skilled in the art will appreciate that the above-described processes are readily enabled using any of a wide variety of available and/or readily configured platforms, including partially or wholly programmable platforms as are known in the art or dedicated purpose platforms as may be desired for some applications. Referring now to FIG. 2, an illustrative approach to such a platform will now be provided.

In this illustrative example an autonomic computational processor 200 comprises a problem solving mechanism selector 201 that operably couples to a memory 202. The memory 202 serves to store, for example, the aforementioned received information regarding a problem as relates to a given process. The problem solving mechanism selector 201 may be configured and arranged (via, for example, programming) to effect the above-described teachings. This can therefore comprise configuring this component to respond to the problem by automatically determining whether to employ an abductive algorithm-based problem solving mechanism 203 or a machine learning algorithm-based problem solving mechanism 204 (and/or, if desired, such other problem solving mechanism as may also be provisioned in a given application setting).

Those skilled in the art will recognize and understand that such an apparatus may be comprised of a plurality of physically distinct elements as is suggested by the illustration shown in FIG. 2. It is also possible, however, to view this illustration as comprising a logical view, in which case one or more of these elements can be enabled and realized via a shared platform and/or a more distributed platform. It will also be understood that such platforms may comprise wholly or at least partially programmable platforms as are known in the art.

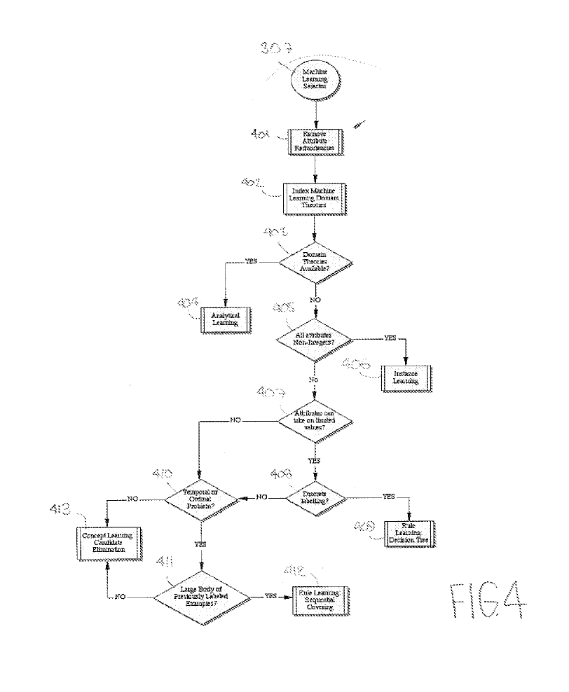

For the purposes of illustration and without intending to suggest limitations a more detailed illustrative approach will now be presented. Referring to FIG. 3, upon determining the existence of a problem, the autonomic computing system can determine 301 whether presentation of the problem is accompanied by any semantic and/or context tag content. (The interested reader will find more regarding this approach in the aforementioned patent application entitled METHOD AND APPARATUS FOR AUGMENTING DATA AND ACTIONS WITH SEMANTIC INFORMATION TO FACILITATE THE AUTONOMIC OPERATIONS OF COMPONENTS AND SYSTEMS.) When such is not the case, this process can then determine 302 whether other attributes are available to otherwise inform the problem solving process. When no such attributes are available, this process can then provide for logging 303 an inability to act in this particular instance and for providing 304 a corresponding message, if desired, via a graphic user interface to alert a user such as a system administrator of this condition.

When attributes are available, this process can instead provide for determining 305 a priority as corresponds to the problem. This determination 305 can be based, for example, upon the state or event to which the problem relates. This can comprise, by one approach, use of a lookup table that is indexed by event and/or state. By another approach this determination can make use of information model domain data as an additional (or substitute) lookup index. Task role or customer information may also be used as a lookup index to further inform such a determination. It would also be possible to use one or more policy rules as a compound index of choice (where the policy rule or rules provide a macro-direction, for example, and one of more of the previously identified items provides micro-directions in this regard).

When this determination 305 identifies the problem as comprising a high priority concern, by one approach a corresponding alert 306 can be provided to a user (via, for example, a graphic user interface of choice). When the problem comprises a lower priority concern, by the illustrated approach this process can provide instead for automatically selecting 307 a machine learning algorithm-based problem solving mechanism (described below in more detail with respect to FIG. 4).

When this process determines 301 that the aforementioned semantic and/or contextual tag(s) are available, such information (along with corresponding event register data) is employed to access 308 an index of available abductive algorithms to facilitate making a determination 309 regarding whether any such algorithms are, in fact, available. By one approach, such algorithms can be identified by algorithm type, with each type having, for example, associated attribute types (metadata) upon which the algorithm operates. A selection index for such abductive algorithm identifiers can comprise an event index that is formed from the event register contents of a previous state, a current perceived state, and the event of interest.

By another approach, if desired, this identity may also specify particular instantiations of the algorithm under different conditions. These additional instantiations could also each have one or more associated attributes and/or metadata specifications. Selecting amongst a plurality of abductive algorithms within the context of using such a current event register could be accomplished by using semantic tagging as may be embedded in the event register. By another approach, if desired, a semantic similarity algorithm can be invoked to assist in the selection process in cases of semantic ambiguity.

Upon selecting one or more candidate abductive algorithms as per the above selection process, corresponding hypothesis features are then fetched 310. By one approach each such hypothesis has associated metadata, attributes, and possibly value expectations associated therewith. Such elements may comprise the fetched features.

This illustrative process then provides for fetching 311 corresponding domain theory and falsifications as indexed via the aforementioned hypothesis features. By a falsification process certain hypothesis are effectively eliminated from a pool of possibly useful hypotheses. Domain theory, in turn, allows for consistency checking among relationships specified by a corresponding abductive algorithm semantic tag (or tags). Those skilled in the art will recognize that falsification and domain theory may be effectively interchangeable in at least some application settings. In general, the falsification approach will often have a higher probability of eliminating a given hypothesis as a candidate.

This process can then make a determination 312 regarding the presence and/or sufficiency of locally available data to effect and execute the selected falsification/domain theory tests. In the absence of such information this process supports the spawning 313 of a request to solicit receipt of such information. Upon receiving 314 such information (or when sufficient information is already available), this process then provides for using 315 such candidate winnowing techniques to select one (or more) abductive algorithms of likely value. This selected abductive algorithm (or algorithms) can then be executed 316 to attempt to solve the presented problem.

As mentioned above, a machine learning algorithm-based problem solving approach 307 may be selected under certain circumstances where an abductive approach does not appear to be useful. With reference to FIG. 4, further corresponding steps in this regard will now be presented.

There are, of course, a variety of different machine learning algorithms that are presently known and others are likely to be developed in the future. Their proper application will often depend, at least to some extent, upon the particular problem to be solved and the data available to seed the learning process. It may also be desirable to prioritize the learning process, at least when possible, as a reflection of the availability of different domain theories that can serve to steer problem exploration and assist with problem statement verification and falsification.

By one approach, modeled knowledge (such as, but not limited to, attributes, relationships, restraints, and/or constraints) as corresponds to, for example, a corresponding information model and a knowledge model (such as a corresponding ontology or ontologies) is examined for redundancy as between these two bodies. Identified redundancies are then eliminated 401. If desired, this step can further comprise examining the modeled knowledge to determine a presence or absence of semantic completeness. For example, when multiple concepts are present, semantic completeness may be found to exist when these multiple concepts relate to and support one another. When semantic completeness is lacking, if desired, additional knowledge can be gathered to attempt to supply the lacking semantic content.

This process then provides for indexing 402 available machine learning domain theories by, for example, examining the characteristics of the existing set of candidate machine learning algorithms to seek possible matches. Upon determining 403 that a useful domain theory is in fact available, control can be passed to the corresponding analytical learning algorithm 404. When such is not the case, however, this process then provides for determining 405 whether the non-redundant modeled knowledge comprises non-integer type content. When true, control can be passed to an instance learning algorithm 406. This instance learning algorithm can comprise, for example, one that is policy-controlled to use a particular nearest neighbor algorithm, one that comprises a locally weighted regression algorithm, one that employs case-based reasoning, or such other algorithm of choice as may be presently known and/or hereafter developed.

When, however, this process detects 405 non-integer modeled knowledge, a subsequent determination 407 can test whether an outcome, dysfunction, and/or event-state mismatch can be mapped into a relatively large set of values or a relatively small set of values. By one approach this point of comparison can be informed, at least in part, by a predetermined policy in this regard. When the outcomes can be mapped to a limited set of values (and further presuming, by one approach, that sufficient discrete labeling 408 (i.e., examples with known target values) is also present) then, by one approach, control can be passed to a decision tree learning-based algorithm 409.

When the modeled knowledge instead assumes a wide variety of potential values and the outcome can be mapped into a large set of values, then a determination 410 can be made to test whether the problem appears to be either temporal or ordinal in nature. Such a check can typically be realized, for example, by a relatively simple inspection of the modeled knowledge itself. When such is the case, a next determination 411 can determine if a relatively large body of labeled examples has already been accumulated. When true, the control can be passed to a sequential covering rule-learning algorithm 412.

When the problem/dysfunction is neither temporal or ordinal in nature, or when only a relatively small body of previously labeled examples has been accrued to date (as may occur when the problem has never been previously encountered), this process will then, by one approach, pass control to a candidate elimination concept-learning algorithm 413 to thereby attempt to at least learn some of the related elements of the problem over time. The results of these learning attempts can serve as one source for the aforementioned previously labeled examples.

These teachings are readily modified to accommodate a variety of other circumstances and/or approaches to system control. For example, by one approach, rules learned as a consequence of a machine learning algorithm can be tagged with the identity of the particular algorithm that generated such rules. So configured, subsequent processing can take place whereby rules are incorporated into a larger autonomic computing knowledge structure with priority being directly associated with the confidence of the machine-learning algorithm that generated such rules. To illustrate, analytical learning, where domain knowledge is used to assist in learning particulars about a problem and then assisting in verification/falsification of the resulting generating rule, could be prioritized as being more deserving of confidence than that of, say, a concept learning approach.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method comprising: at an autonomic computational processor:
providing at least one abductive algorithm-based problem solving mechanism;
providing at least one machine learning algorithm-based problem solving mechanism;
receiving information regarding a problem as relates to a process;
automatically determining which of the at least one abductive algorithm-based problem solving mechanism and the at least one machine learning algorithm-based problem solving mechanism to use to attempt to resolve the problem.

2. The method of claim 1 wherein the autonomic computation processor comprises a communications network processor that is arranged and configured to facilitate at least one of network traffic data and network traffic status.

3. The method of claim 1 wherein providing at least one machine learning algorithm-based problem solving mechanism comprises providing a plurality of machine learning algorithm-based problem solving mechanisms.

4. The method of claim 1 wherein the problem relates to at least one of:
an unrecognized process state;
an unrecognized process event.

5. The method of claim 1 wherein receiving information regarding a problem as relates to a process comprises receiving event-based information regarding at least one of process state and process event information.

6. The method of claim 5 wherein receiving information regarding a problem as relates to a process further comprises receiving supplemental information comprising at least one of:
semantical information;
at least one contextual tag.

7. The method of claim 6 wherein automatically determining which of the at least one abductive algorithm-based problem solving mechanism and the at least one machine learning algorithm-based problem solving mechanism to use to attempt to resolve the problem comprises, at least in part, determining whether sufficient supplemental information has been received to facilitate using an abductive algorithm-based problem solving mechanism.

8. The method of claim 7 wherein automatically determining which of the at least one abductive algorithm-based problem solving mechanism and the at least one machine learning algorithm-based problem solving mechanism to use to attempt to resolve the problem further comprises, when sufficient supplemental information has been received to facilitate using an abductive algorithm-based problem solving mechanism, then determining whether a potentially useful abductive algorithm-based problem solving mechanism is available.

9. An autonomic computational processor comprising:
at least one abductive algorithm-based problem solving mechanism;
at least one machine learning algorithm-based problem solving mechanism;
a memory having stored therein received information regarding a problem as relates to a process;
a problem solving mechanism selector operably coupled to the memory and being configured and arranged to automatically determine which of the at least one abductive algorithm-based problem solving mechanism and the at least one machine learning algorithm-based problem solving mechanism to use to attempt to resolve the problem.

10. The autonomic computational processor of claim 9 wherein the at least one machine learning algorithm-based problem solving mechanism comprises a plurality of machine learning algorithm-based problem solving mechanisms.

11. The autonomic computational processor of claim 9 wherein the problem relates to at least one of:
an unrecognized process state;
an unrecognized process event.

12. The autonomic computational processor of claim 9 wherein the received information regarding a problem as relates to a process comprises received event-based information regarding at least one of process state and process event information.

13. The autonomic computational processor of claim 12 wherein the received information regarding a problem as relates to a process further comprises received supplemental information comprising at least one of:
semantical information;
at least one contextual tag.

14. The autonomic computational processor of claim 13 wherein the problem solving mechanism selector is further configured and arranged to automatically determine which of the at least one abductive algorithm-based problem solving mechanism and the at least one machine learning algorithm-based problem solving mechanism to use to attempt to resolve the problem by, at least in part, determining whether sufficient supplemental information has been received to facilitate using an abductive algorithm-based problem solving mechanism.

15. The autonomic computational processor of claim 4 wherein the problem solving mechanism selector is further configured and arranged to automatically determine which of the at least one abductive algorithm-based problem solving mechanism and the at least one machine learning algorithm-based problem solving mechanism to use to attempt to resolve the problem by, when sufficient supplemental information has been received to facilitate using an abductive algorithm-based problem solving mechanism, then determining whether a potentially useful abductive algorithm-based problem solving mechanism is available.

16. A method comprising: at an autonomic computational processor:
providing at least one substantially closed loop problem solving mechanism;
providing at least one substantially open loop problem solving mechanism;
receiving information regarding a problem as relates to a process; automatically determining which of the at least one closed loop problem solving mechanism and the at least one substantially open loop problem solving mechanism to use to attempt to resolve the problem.

17. The method of claim 16 wherein the substantially closed loop problem solving mechanism comprises, at least in part, an abductive algorithm-based problem solving mechanism.

18. The method of claim 16 wherein the substantially open loop problem solving mechanism comprises, at least in part, a machine learning algorithm-based problem solving mechanism.

19. The method of claim 16 wherein:
the substantially closed loop problem solving mechanism comprises, at least in part, an abductive algorithm-based problem solving mechanism;
the substantially open loop problem solving mechanism comprises, at least in part, a machine learning algorithm-based problem solving mechanism.
